(19) United States
(12) Patent Application Publication
(10) Pub. No.: US 2018/0195858 A1
(43) Pub. Date: Jul. 12, 2018

(54) MEASUREMENT APPARATUS FOR MEASURING SHAPE OF TARGET OBJECT, SYSTEM AND MANUFACTURING METHOD

(71) Applicant: CANON KABUSHIKI KAISHA, Tokyo (JP)

(72) Inventor: Yuya Nishikawa, Utsunomiya-shi (JP)

(21) Appl. No.: 15/741,877

(22) PCT Filed: Jun. 29, 2016
(86) PCT No.: PCT/JP2016/003121

§ 371 Date: Jan. 4, 2018

(30) Foreign Application Priority Data
Jul. 9, 2015 (JP) 2015-138158

(51) Int. Cl. G01B 11/25; G01B 9/02; G01B 21/04

(52) U.S. Cl. CPC G01B 11/2513; G01B 21/045; G01B 9/02071

(57) ABSTRACT

A measurement apparatus includes: a projection optical system; an illumination unit; an imaging unit configured to image a target onto which pattern light has been projected by the projection optical system, thereby capturing a first image of the target by the pattern light reflected by the target; and a processing unit configured to obtain information on the shape of the target. The illumination unit includes light emitters arranged around an optical axis of the projection optical system symmetrically with respect to the optical axis. The processing unit corrects the first image by using a second image of the target and obtains the shape information on the basis of the corrected image, wherein the imaging unit images the target object illuminated by the light emitters to capture the second image by light emitted from the light emitters and reflected by the target object.

### TECHNICAL FIELD

Aspects of the present invention generally relate to a measurement apparatus for measuring the shape of a target object, system, and manufacturing method.

### BACKGROUND ART

Optical measurement is known as one of techniques for measuring the shape of a target object. There are various methods in optical measurement. One of them is a method called as pattern projection. In a pattern projection method, the shape of a target object is measured as follows. A predetermined pattern is projected onto a target object. An image of the target object is captured by an imaging section. A pattern in the captured image is detected. On the basis of the principle of triangulation, distance information at each pixel position is calculated, thereby obtaining information on the shape of the target object.

In this measurement method, the coordinate of each line of a projected pattern is detected on the basis of the spatial distribution information of pixel values (the amount of received light) in a captured image. The spatial distribution information of the amount of the received light is data that contains the effects of reflectivity distribution arising from the pattern and/or fine shape, etc. of the surface of the target object. Because of them, in some cases, a detection error occurs in the detection of the pattern coordinates, or it could be impossible to perform the detection at all. This results in low precision in the information on the calculated shape of the target object.

The following measurement method is disclosed in PTL 1. An image at the time of projection of pattern light (hereinafter referred to as “pattern projection image”) is acquired. After that, uniform light is applied to a target object by using a liquid crystal shutter, and an image under uniform illumination (hereinafter referred to as “grayscale image”) is acquired. With the use of the grayscale image as correction data, image correction is performed so as to remove the effects of reflectivity distribution on the surface of the target object from the pattern projection image.

The following measurement method is disclosed in PTL 2. Pattern light and uniform illumination light are applied to a target object. The direction of polarization of the pattern light and the direction of polarization of the uniform illumination light are different from each other by 90°. Imagers corresponding to the respective directions of polarization capture a pattern projection image and a grayscale image respectively. After that, image processing for obtaining distance information from a difference image, which is indicative of the difference between the two, is performed. In this measurement method, the timing of acquisition of the pattern projection image and the timing of acquisition of the grayscale image are the same as each other, and correction for removing the effects of reflectivity distribution on the surface of the target object from the pattern projection image is performed.

In the measurement method disclosed in PTL 1, the timing of acquisition of the pattern projection image and the timing of acquisition of the grayscale image are different from each other. In some imaginable uses and applications of a measurement apparatus, distance information is acquired while either a target object or the imaging section of a measurement apparatus moves, or both. In such a case, the relative position of them changes from one time to another, resulting in a difference between the point of view for capturing the pattern projection image and the point of view for capturing the grayscale image. An error will occur if correction is performed by using such images based on the different points of view.

In the measurement method disclosed in PTL 2, the pattern projection image and the grayscale image are acquired at the same time by using polarized beams the directions of polarization of which are different from each other by 90°. The surface of a target object has local angular variations because of irregularities in the fine shape of the surface of the target object (surface roughness). Because of the local angular variations, reflectivity distribution on the surface of the target object differs depending on the direction of polarization. This is because the reflectivity of incident light in relation to the angle of incidence differs depending on the direction of polarization. An error will occur if correction is performed by using images containing information based on reflectivity distributions different from each other.

### CITATION LIST

### Patent Literature

PTL 1: Japanese Patent Laid-Open No. 3-289505

PTL 2: Japanese Patent Laid-Open No. 2002-213931

### SUMMARY OF INVENTION

Even in a case where the relative position of a target object and an imaging section changes, some aspects of the invention make it possible to reduce a measurement error arising from the surface roughness of the target object, thereby measuring the shape of the target object with high precision.

Regarding a measurement apparatus for measuring the shape of a target object, one aspect of the invention is as follows. The measurement apparatus comprises: a projection optical system, an illumination unit, an imaging unit, and a processing unit. The projection optical system is configured to project pattern light onto the target object. The illumination unit is configured to illuminate the target object. The imaging unit is configured to image the target object onto which the pattern light has been projected by the projection optical system, thereby capturing a first image of the target object by the pattern light reflected by the target object. The processing unit is configured to obtain information on the shape of the target object. The illumination unit includes plural light emitters arranged around an optical axis of the projection optical system symmetrically with respect to the optical axis of the projection optical system. The imaging unit images the target object illuminated by the plural light emitters to capture a second image by light emitted from the plural light emitters and reflected by the target object. The processing unit corrects the first image by using the second image of the target object and obtains the information on the shape of the target object on the basis of the corrected image.

Further features of the present invention will become apparent from the following description of exemplary embodiments with reference to the attached drawings.

### BRIEF DESCRIPTION OF DRAWINGS

FIG. 1 is a schematic view of the structure of a measurement apparatus according to a first embodiment.

FIG. 2A is a view of a measurement scene according to the first embodiment.

FIG. 2B is a view of a measurement scene according to a second embodiment.

FIG. 3 is a view of a projection pattern according to the first embodiment.

FIG. 4 is a view of a grayscale image illumination unit according to the first embodiment.

FIG. 5 is a view of a grayscale image illumination unit according to a variation example of the first embodiment.

FIG. 6 is a flowchart of measurement according to the first embodiment.

FIG. 7A is a model diagram of the fine shape of a surface of a target object.

FIG. 7B is a graph that shows a relationship between the angle of inclination of the target object and the reflectivity thereof.

FIG. 8 is a diagram that illustrates a relationship between the angle of a target object and a measurement apparatus.

FIG. 9 is a graph that shows a relationship between the angle of incidence and reflectivity.

FIG. 10 is a diagram that illustrates a relationship between a relationship between the angle of the surface of the target object and reflectivity.

FIG. 11 is a flowchart of procedure according to the second embodiment.

FIG. 12 is a flowchart of procedure according to a third embodiment.

FIG. 13 is a schematic view of the structure of a measurement apparatus according to a fourth embodiment.

FIG. 14 is a diagram that illustrates a system including the measurement apparatus and a robot.

### DESCRIPTION OF EMBODIMENTS

With reference to the accompanying drawings, some preferred embodiments of the invention will now be explained. In each of the drawings, the same reference numerals are assigned to the same members to avoid redundant description.

### First Embodiment

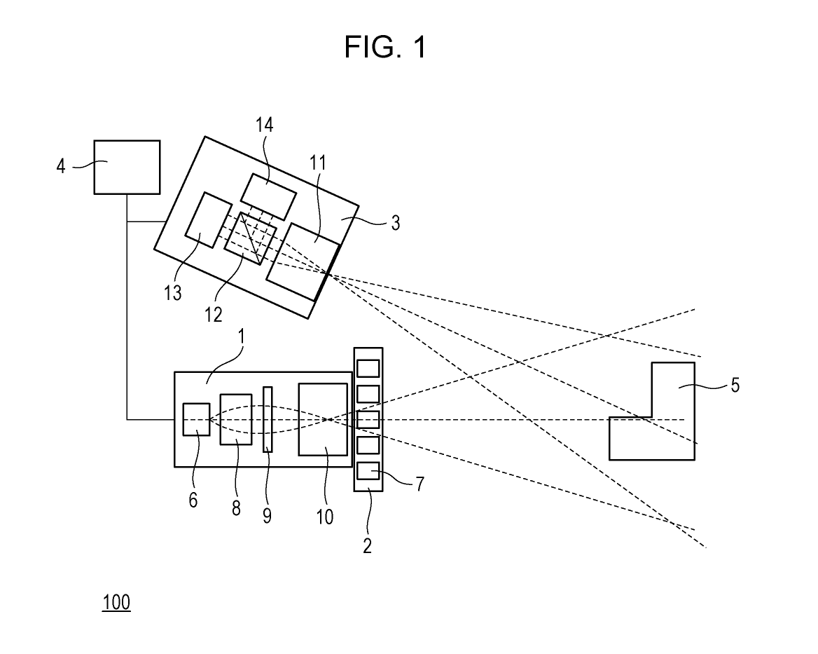

FIG. 1 is a schematic view of the structure of a measurement apparatus 100 according to one aspect of the invention. Broken lines represent beams. As illustrated in FIG. 1, the measurement apparatus 100 includes a distance image illumination unit 1, a grayscale image illumination unit 2 (illumination section), an imaging unit 3 (imaging section), and an arithmetic processing unit 4 (processing section). For shape information (for example, three-dimensional shape, two-dimensional shape, position and orientation, etc.), the measurement apparatus 100 uses a pattern projection method to measure the shape of a target object 5 (physical object). Specifically, a distance image and a grayscale image are acquired, and the position and orientation of the target object 5 are measured by performing model fitting using the two images. The distance image mentioned above is an image that represents the three-dimensional information of points on the surface of a target object, wherein each pixel has depth information. The grayscale image mentioned above is an image acquired by imaging the target object under uniform illumination. The model fitting is performed on a prepared-in-advance CAD model of the target object 5. This is based on the premise that the three-dimensional shape of the target object 5 is known. The target object 5 is, for example, a metal part or an optical member.

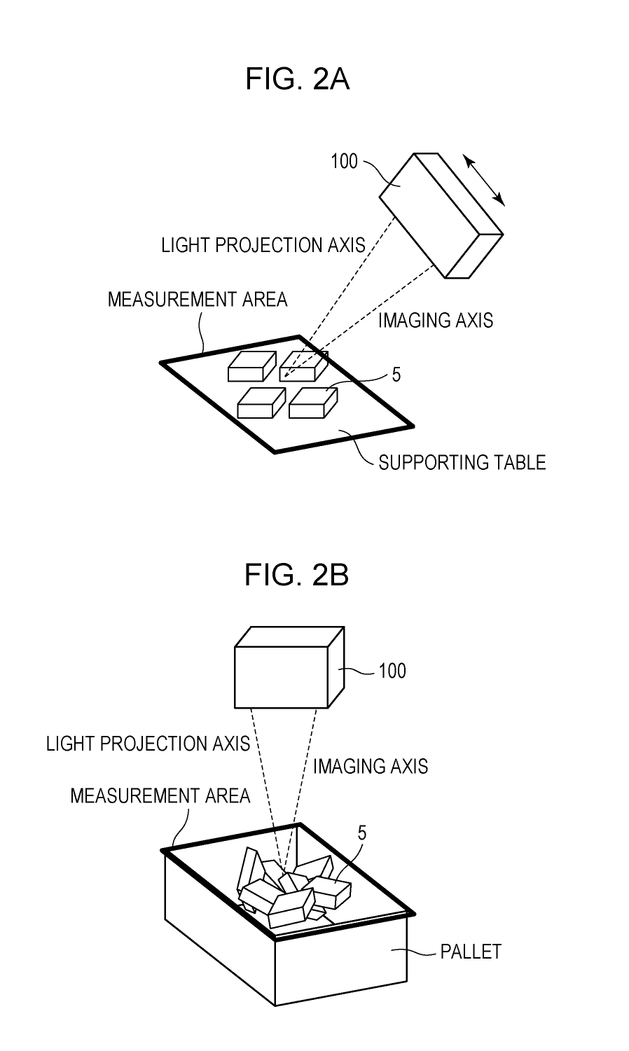

A relationship between the measurement apparatus 100 and the state of arrangement of the target objects 5 is illustrated in FIGS. 2A and 2B. In the measurement scene of the present embodiment, as illustrated in FIG. 2A, the target objects 5 are substantially in an array state on a flat supporting table inside the area of measurement. The measurement apparatus 100 is tilted with respect to the top surface of the target objects 5 so as to avoid the optical axis of the distance image illumination unit 1 and the optical axis of the imaging unit 3 from being under the conditions of regular reflection. The light projection axis represents the optical axis of a projection optical system 10 described later. The imaging axis represents the optical axis of an imaging optical system described later.

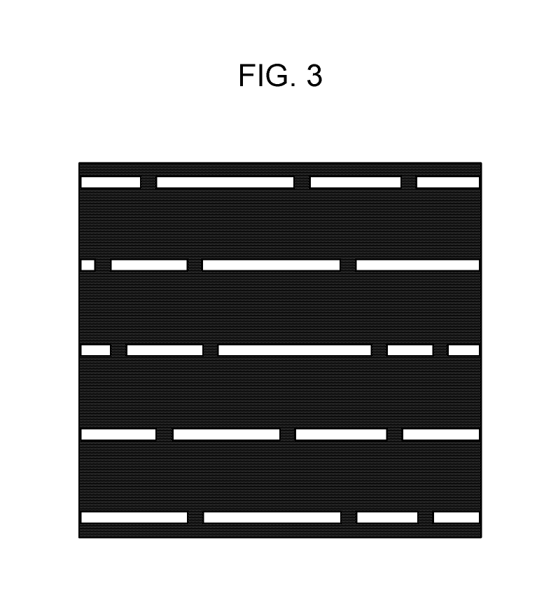

The distance image illumination unit 1 includes a light source 6, an illumination optical system 8, a mask 9, and the projection optical system 10. The light source 6 is, for example, a lamp. The light source 6 emits non-polarized light that has a wavelength different from that of light sources 7 of the grayscale image illumination unit 2 described later. The wavelength of light emitted by the light source 6 is λ1. The wavelength of light emitted by the light source 7 is λ2. The illumination optical system 8 is an optical system for uniformly applying the beam of light emitted from the light source 6 to the mask 9 (pattern light forming section). The mask 9 has a pattern that is to be projected onto the target object 5. For example, a predetermined pattern is formed by chromium-plating a glass substrate. An example of the pattern of the mask 9 is a dot line pattern coded by means of dots (identification portion) as illustrated in FIG. 3. Dots are expressed as white line disconnection points. The projection optical system 10 is an optical system for forming an image of the pattern of the mask 9 on the target object 5. This optical system includes a group of lenses, mirrors, and the like. For example, it is an image-forming system that has a single image-forming relation, and has an optical axis. Though a method of projecting a fixed mask pattern is described in the present embodiment, the scope of the invention is not limited thereto. Pattern light may be projected (formed) onto the target object 5 by using a DLP projector or a liquid crystal projector.

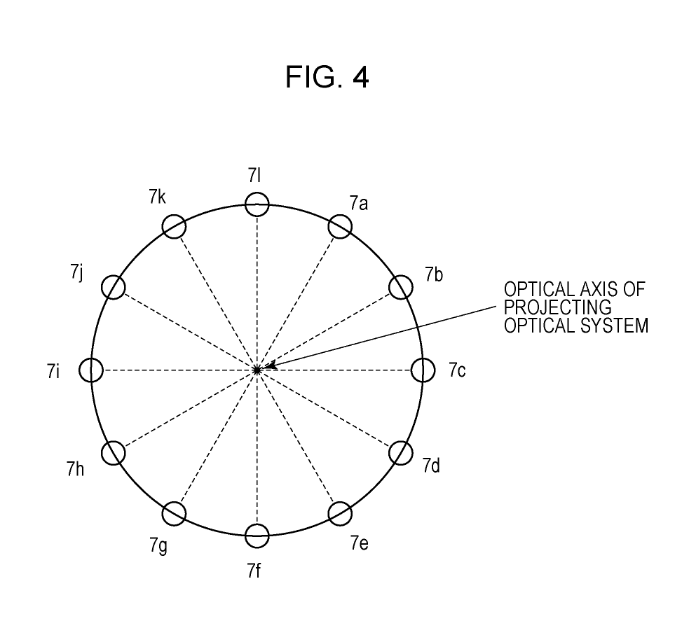

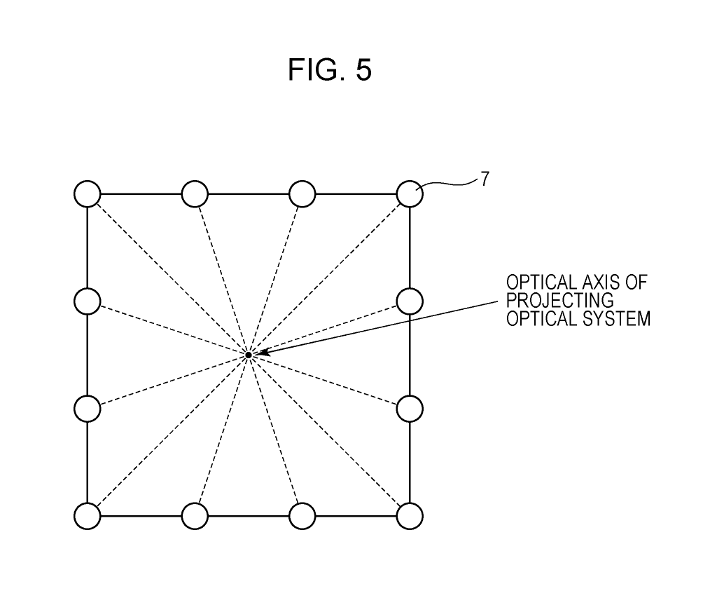

The grayscale image illumination unit 2 includes plural light sources 7 (light emitters), which are light sources 7a to 7l. Each of these light sources is, for example, an LED, and emits non-polarized light. FIG. 4 is a view of the grayscale image illumination unit 2, taken along the direction of the optical axis of the projection optical system 10. As illustrated in FIG. 4, the plural light sources 7a to 7l are arranged in a ring shape at intervals around the optical axis (going in a direction perpendicular to the sheet face of the figure) of the projection optical system 10 of the distance image illumination unit 1. The light sources 7a and 7g are arranged symmetrically with respect to the optical axis of the projection optical system 10. The light sources 7b and 7h are arranged symmetrically with respect to the optical axis of the projection optical system 10. The same holds true for the light sources 7c and 7i, the light sources 7d and 7j, the light sources 7e and 7k, and the light sources 7f and 7l. In a case where the light source is an LED, its light emitting part has a certain area size. In such a case, for example, it is ideal if the center of the light emitting part is at the symmetrical array position described above. Since the light sources 7 are arranged in this way, it is possible to illuminate the target object from two directions that are symmetric with each other with respect to the optical axis of the projection optical system 10. Preferably, the light sources 7a to 7l should have same characteristics of wavelength, polarization, brightness, and light distribution. Light distribution characteristics represent differences in the amount of light among the directions of emission propagation. Therefore, preferably, the light sources 7a to 7i should be the products of the same model number. Though the plural light sources are arranged in a ring shape in FIG. 4, the scope of the invention is not limited to such a ring array. It is sufficient as long as two light sources making up each pair are at an equal distance from the optical axis of the projection optical system in a plane perpendicular to the optical axis. For example, the array shape may be a square as illustrated in FIG. 5. The number of the light sources 7 is not limited to twelve. It is sufficient as long as there is an even number of light sources making up pairs.

The imaging unit 3 includes an imaging optical system 11, a wavelength division element 12, and image sensors 13 and 14. The imaging unit 3 is a shared unit used for the purpose of both distance image measurement and grayscale image measurement. The imaging optical system 11 is an optical system for forming a target image on the image sensor 13, 14 by means of light reflected by the target object 5. The wavelength division element 12 is an element for optical separation of the light source 6 (λ1) and the light sources 7 (λ2). For example, the wavelength division element 12 is a dichroic mirror. The wavelength division element 12 allows the light of the light source 6 (λ1) to pass through itself toward the image sensor 13, and reflects the light of the light sources 7 (λ2) toward the image sensor 14. The image sensor 13, 14 are, for example, a CMOS sensor or a CCD sensor. The image sensor 13 (first imaging unit) is an element for capturing a pattern projection image. The image sensor 14 (second imaging unit) is an element for capturing a grayscale image.

The arithmetic processing unit 4 is a general computer that functions as an information processing apparatus. The arithmetic processing unit 4 includes a processor such as CPU, MPU, DSP, and FPGA and includes a memory such as DRAM.

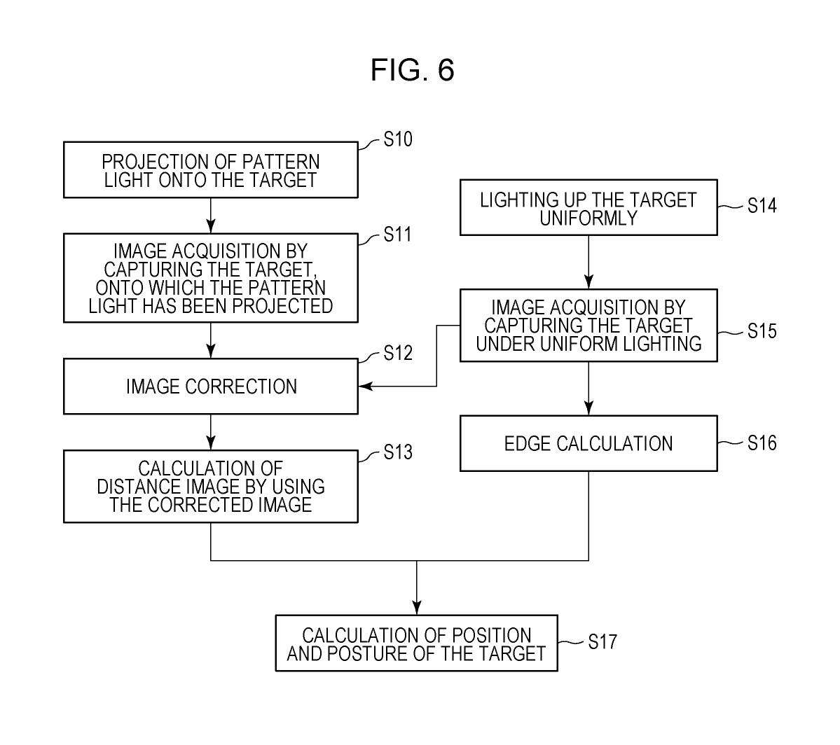

FIG. 6 is a flowchart of a measurement method. First, procedure for acquiring a distance image will now be explained. In the distance image illumination unit 1, the beam of light emitted from the light source 6 is applied uniformly by the illumination optical system 8 to the mask 9, and pattern light originating from the pattern of the mask 9 is projected by the projection optical system 10 onto the target object 5 (S10). From a direction that is different from that of the distance image illumination unit 1, the image sensor 13 of the imaging unit 3 captures the target object 5, onto which the pattern light has been projected from the distance image illumination unit 1, thereby acquiring a pattern projection image (first image) (S11). On the basis of the principle of triangulation, the arithmetic processing unit 4 calculates a distance image (information on the shape of the target object 5) from the acquired image (S13). In the present embodiment, it is assumed that the apparatus measures the position and orientation of the target object 5 while moving a robot arm that is provided with a unit that includes the distance image illumination unit 1, the grayscale image illumination unit 2, and the imaging unit 3. The robot arm (gripping unit) grips the target object, and moves and/or rotates it. For example, as illustrated in FIG. 2A, a unit that includes the distance image illumination unit 1, the grayscale image illumination unit 2, and the imaging unit 3 of the measurement apparatus 100 is movable. Preferably, the pattern light projected onto the target object 5 should originate from a pattern with which it is possible to calculate a distance image from a single pattern projection image. If a measurement method in which a distance image is calculated from plural captured images is employed, due to a visual field shift occurring in the captured images because of robot arm movement, it is impossible to calculate a distance image with high precision. One example of a pattern with which it is possible to calculate a distance image from a single pattern projection image is a dot line pattern such as one illustrated in FIG. 3. The distance image is calculated from the single captured image by projecting the dot line pattern onto the target object 5 and by discovering correspondences between the projection pattern and the captured image on the basis of the dot position relationship. Though the dot line pattern is mentioned above as the projection pattern, the scope of the invention is not limited thereto. Any other projection pattern may be employed as long as it is possible to calculate a distance image from a single pattern projection image.

Next, procedure for acquiring a grayscale image will now be explained. In the present embodiment, edges corresponding to the contour and edge lines of the target object 5 are detected from a grayscale image, and the edges are used as image features for calculating the position and orientation of the target object 5. First, the grayscale image illumination unit 2 floodlights the target object 5 (S14). This light for illuminating the target object 5 has, for example, uniform light intensity distribution. Next, the image sensor 14 of the imaging unit 3 captures the target object 5 under uniform illumination by the grayscale image illumination unit 2, thereby acquiring a grayscale image (second image) (S14). For edge calculation (S16), the arithmetic processing unit 4 performs edge detection processing by using the acquired image.

In the present embodiment, the capturing operation for a distance image and the capturing operation for a grayscale image are performed in synchronization with each other. Therefore, the illumination of (the projection of pattern light onto) the target object 5 by the distance image illumination unit 1 and the uniform illumination of the target object 5 by the grayscale image illumination unit 2 are performed at the same time. The image sensor 13 captures the target object 5 onto which the pattern light has been projected by the projection optical system 10, thereby acquiring the first image of the target object 5 by means of the pattern light reflected by the target object 5. The image sensor 14 captures the target object 5 lit up by the plural light sources 7 to acquire the second image of the target object 5 by means of the light reflected by the target object 5 after coming from the plural light sources 7. Since the capturing operation for the distance image and the capturing operation for the grayscale image are performed in synchronization with each other, even in a situation in which the relative position of the target object 5 and the imaging unit 3 changes, it is possible to perform image acquisition based on the same point of view. The arithmetic processing unit 4 calculates the position and orientation of the target object 5 by using the calculation results of S13 and S16 (S17).

In the calculation of the distance image in S13, the arithmetic processing unit 4 detects the coordinate of each line of the projected pattern on the basis of the spatial distribution information of the pixel values (the amount of the received light) in the captured image. The spatial distribution information of the amount of the received light is data that contains the effects of reflectivity distribution arising from the pattern and/or fine shape, etc. of the surface of the target object. Because of them, in some cases, a detection error occurs in the detection of the pattern coordinates, or it could be impossible to perform the detection at all. This results in low precision in the information on the calculated shape of the target object. To avoid this, in S12, the arithmetic processing unit 4 corrects the acquired image, thereby reducing an error due to the effects of reflectivity distribution arising from the pattern and/or fine shape, etc. of the surface of the target object.

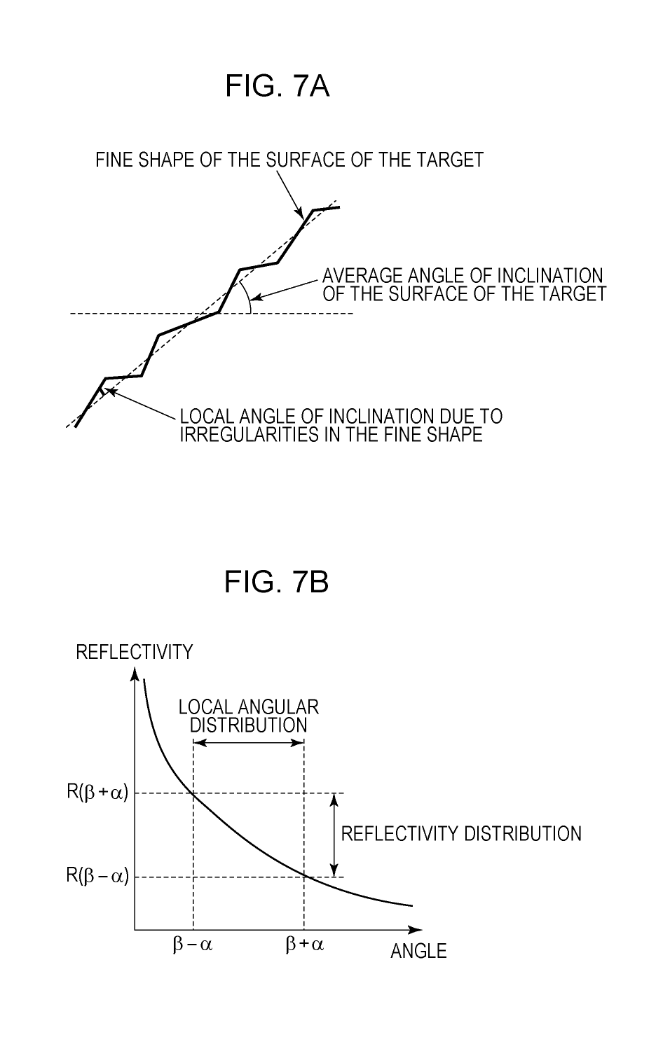

The reflectivity distribution of a target object will now be explained. First, with reference to FIGS. 7A and 7B, the model of reflectivity distribution arising from the fine shape of the surface of a target object will now be explained. In FIG. 7A, the solid line represents the fine shape of the surface of a target object (surface roughness). The broken line represents the average angle of inclination of the surface of the target object. As illustrated in FIG. 7A, the surface of the target object has local angular variations because of irregularities in the fine shape of the surface of the target object. Given that the angular variations are within a range from −α° to +α° and that the average angle of inclination of the surface of the target object is β°, the inclination of the surface of the target object varying from one region to another is within a range from β−α° to β+α°. FIG. 7B is a graph that shows a relationship between the angle of inclination θ of the target object and the reflectivity R(θ) thereof. The term “reflectivity” mentioned here means a ratio of the amount of light reflected by the surface of a target object and going in a certain direction to the amount of incident light coming in a certain direction. For example, the reflectivity may be expressed as a ratio of the amount of light received at an imaging unit after reflection toward the imaging unit to the amount of incident light. In a case where the inclination of the surface of the target object varying from one region to another is within a range from β−α° to β+α° as described above, the reflectivity varies from one region to another within a range from R(β−α) to R(β+α), which means the reflectivity distribution of R(β−α) to R(β+α). That is, the reflectivity distribution depends on the fine shape of the surface and the angular characteristics of reflectivity.

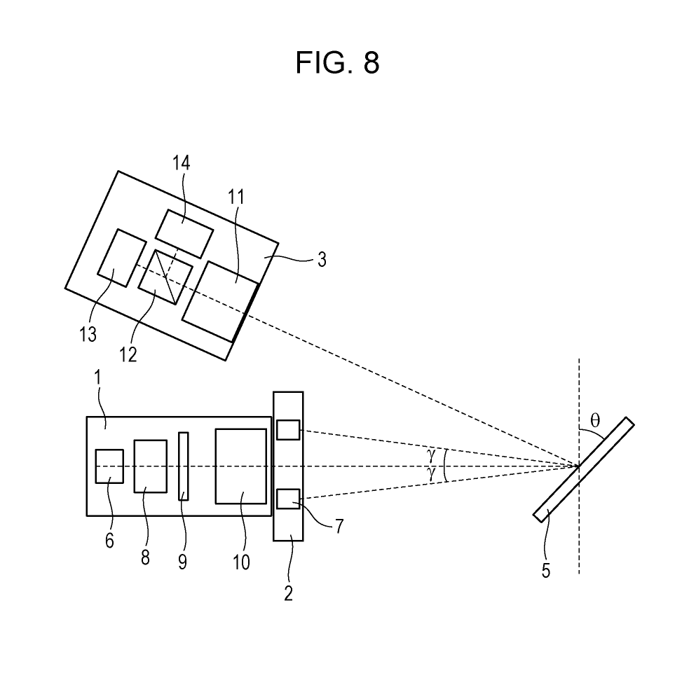

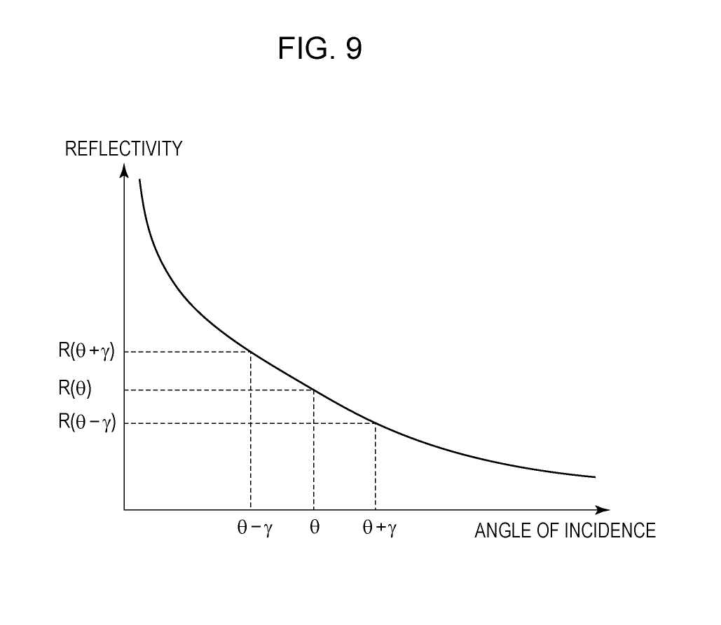

FIG. 8 is a diagram that illustrates a relationship between the optical axis of the projection optical system 10 and, among the light sources 7 of the grayscale image illumination unit 2, two light sources that are arranged as a symmetric pair with respect to the optical axis of the projection optical system 10. FIG. 9 is a graph that shows a relationship between the angle of incidence and reflectivity. Since the paired light sources 7 are arranged symmetrically with respect to the optical axis of the projection optical system 10, the target object 5 is floodlit therefrom in two directions that are symmetric with respect to the optical axis of the projection optical system 10. Let θ be the angle of inclination of the target object 5. Let γ be the angle formed by the line segment from the light source 7 to the target object 5 and the optical axis of the projection optical system 10. Given these definitions, in a region where the angular characteristics of reflectivity are roughly linear as illustrated in FIG. 9, the following approximate equation (1) holds:

R(θ)=(R(θ+γ)+R(θ−γ))/2 (1).

That is, in the region where the angular characteristics of reflectivity are roughly linear, local reflectivity (reflectivity distribution) for a pattern projection image and local reflectivity for a grayscale image are roughly equal to each other. Therefore, with the use of the grayscale image acquired in S15, the arithmetic processing unit 4 corrects (S12) the pattern projection image acquired in S11 before the calculation of the distance image in S13. By this means, it is possible to remove, from the pattern projection image, the effects of reflectivity distribution arising from the fine shape of the surface of the target object. Next, in S13, the distance image is calculated using the corrected image. Therefore, in the calculation of the distance image in S13, it is possible to reduce an error due to the effects of reflectivity distribution arising from the pattern and/or fine shape, etc. of the surface of the target object. This makes it possible to obtain, with high precision, the information on the shape of the target object.

If the light sources 7 differ in wavelength, polarization, brightness, and/or light distribution characteristics from one another, reflectivity and the amount of reflected light differ because of the difference in these parameters, resulting in a difference between the reflectivity distribution of a pattern projection image and the reflectivity distribution of a grayscale image. For this reason, preferably, the light sources 7 should have equal wavelength, equal polarization, equal brightness, and equal light distribution characteristics. If the light distribution characteristics differ from one light source to another, the angular distribution of the amount of incident light coming toward the surface of a target object differs. Consequently, in such a case, the amount of reflected light differs from one light source to another due to the angle difference in reflectivity.

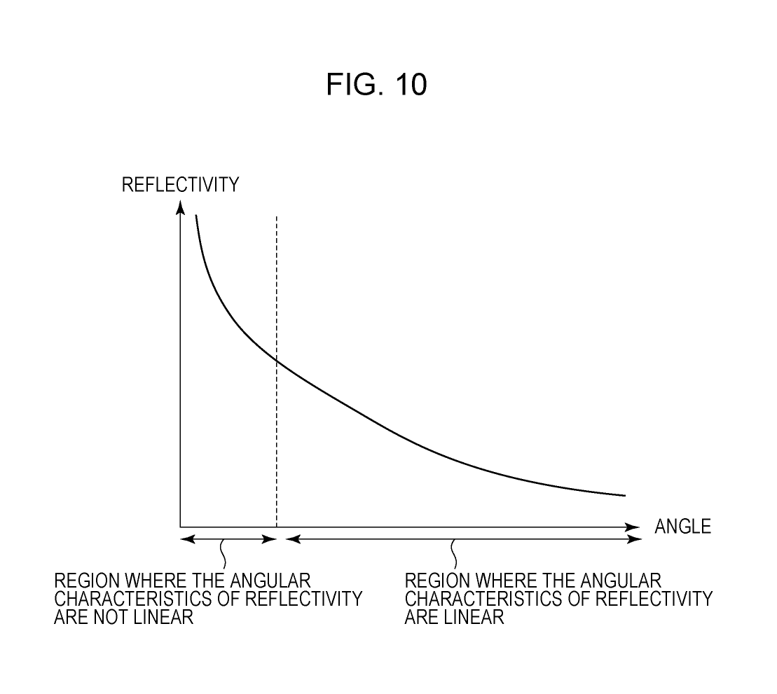

In general, in the angular characteristics of reflectivity, as illustrated in FIG. 10, the change in reflectivity versus angle is small under conditions deviated from the conditions of regular reflection (the angle of incidence: zero); therefore, it exhibits substantial linearity in relation to the angle of incidence. On the other hand, under conditions near the conditions of regular reflection, the change in reflectivity versus angle is large, meaning that the linearity is lost (nonlinear). In view of the above, in the present embodiment, the arithmetic processing unit 4 determines whether it is OK to carry out image correction or not on the basis of the relative orientation of the target object and the measurement apparatus. In the present embodiment, as illustrated in FIG. 2A, the target objects 5 are substantially in an array state on a flat supporting table. Therefore, the relative orientation θ of the target object and the measurement apparatus is known in advance. Therefore, the relative orientation θ of the target object and the measurement apparatus is compared with a predetermined angle threshold θₜₕ, and image correction is carried out if the relative orientation θ is greater than the predetermined angle threshold θₜₕ. The predetermined angle threshold θₜₕ is, for example, decided on the basis of a relationship between angle and the ratio of improvement in precision as a result of image correction at the part where the approximate shape of the target object is known, wherein the measurement is conducted while tilting the target object. The angle at which the effect of the image correction becomes substantially zero is set as this threshold. The ratio of improvement in precision as a result of image correction is a value calculated by dividing measurement precision after the correction by measurement precision before the correction.

In the present embodiment, since the measurement apparatus is significantly tilted with respect to the target object 5, the relative orientation θ of the target object and the measurement apparatus is greater than the angle threshold θₜₕ. Therefore, image correction is carried out. The image correction is performed by the arithmetic processing unit 4 with the use of a pattern projection image I₁(x, y) and a grayscale image I₂(x, y). A corrected pattern projection image I₁′(x, y) is calculated using the following formula (2):

I₁′(x,y)=I₁(x,y)/I₂(x,y) (2).

where x, y denotes pixel coordinate values on the image sensor.

As expressed in the formula (2), the correction is based on division in the above example. However, the method of correction is not limited to division. For example, as expressed in the following formula (3), the correction may be based on subtraction.

I₁′(x,y)=I₁(x,y)−I₂(x,y) (3).

In the embodiment described above, since the light sources for grayscale image illumination are arranged symmetrically with respect to the optical axis of the projection optical system 10, light intensity distribution for a pattern projection image and light intensity distribution for a grayscale image are roughly equal to each other. Therefore, it is possible to correct the pattern projection image by using the grayscale image easily with high precision. For this reason, even in a case where the relative position of the target object and the imaging unit changes, it is possible to reduce a measurement error due to the effects of reflectivity distribution arising from the fine shape of the surface of the target object. Therefore, it is possible to obtain information on the shape of the target object with high precision.

Though the light sources 7 are arranged symmetrically with respect to the optical axis of the projection optical system 10, strict symmetry in the light-source layout is not required as long as an error occurring through image correction is within a predetermined tolerable range. The symmetric layout in the present embodiment encompasses such a layout not exceeding error tolerance. For example, the target object 5 may be floodlit therefrom in two directions that are asymmetric with respect to the optical axis of the projection optical system 10 within a range in which reflectivity in relation to the angle of the surface of the target object is roughly linear.

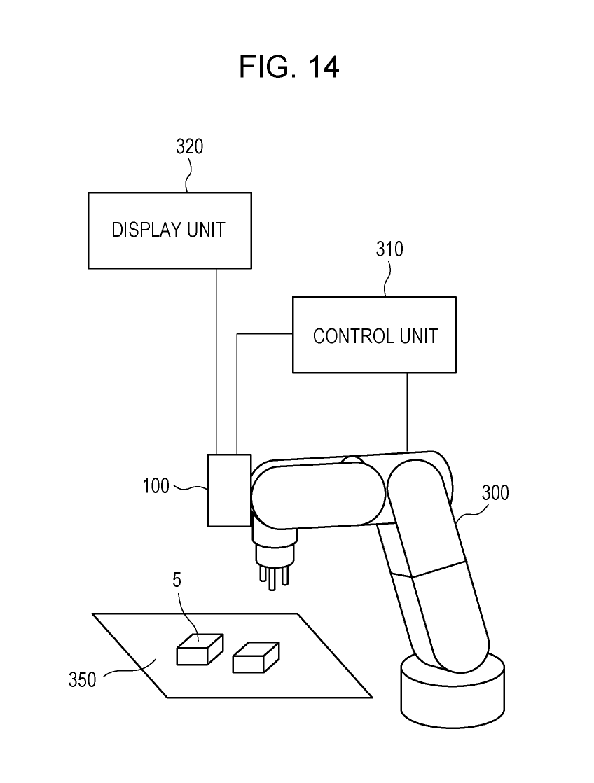

In the illustrated example of FIG. 14, it is assumed that the measurement apparatus 100 of the present embodiment is mounted on a robot arm 300 in an object gripping control system. The measurement apparatus 100 measures the position and orientation of the target object 5 on a supporting table 350. A control unit 310 for the robot arm 300 controls the robot arm 300 by using the result of measurement of the position and orientation. Specifically, the robot arm 300 grips, moves, and/or rotates the target object 5. The control unit 310 includes an arithmetic processor, for example, a CPU, and a storage device, for example, a memory. Measurement data acquired by the measurement apparatus 100, and/or an acquired image, may be displayed on a display unit 320, for example, a display device.

### Second Embodiment

A second embodiment will now be explained. The difference from the foregoing first embodiment lies in, firstly, the measurement scene, and secondly, in the addition of determination processing regarding the correction of an error arising from the fine shape of the surface of a target object in the image correction step of S12. In the first embodiment, it is assumed that, with the use of an image captured under conditions in which the target objects 5 are substantially in an array state, the entire image is corrected in S12. In the measurement scene of the present embodiment, there is a pile of the target objects 5 in a non-array state inside a pallet as illustrated in FIG. 2B. In the present embodiment, orientation differs from one target object 5 to another. Therefore, there is a case where the measurement apparatus 100 is in near-regular-reflection orientation with respect to the top surface of the target object 5. Therefore, under some angular conditions, the approximate equation (1) described earlier does not hold. In such a case, if the correction of an error arising from the fine shape of the surface of a target object is carried out, it will worsen the measurement precision. For this reason, for the purpose of measuring the position and orientation of the target object with high precision, it is better not to apply the correction to, in the captured image, the area where the target object is under near-regular-reflection conditions.

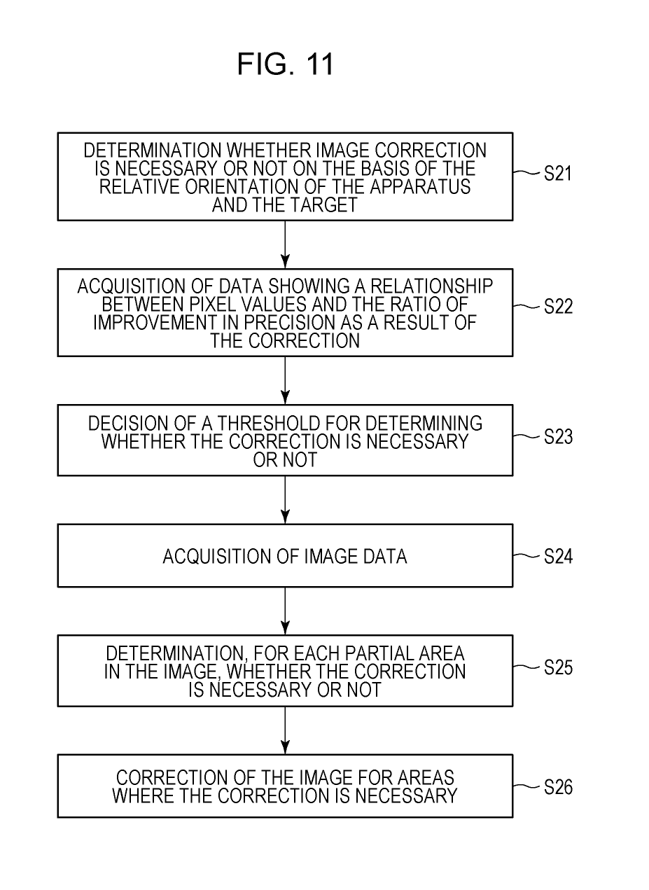

In view of the above, in the present embodiment, for each partial area in an image, it is determined in S12 whether correction is necessary or not. With reference to the flowchart of FIG. 11, procedure for realizing the above intelligent correction processing will now be explained. In the present embodiment, for each partial area in an image, it is determined whether the correction of an error arising from the fine shape of the surface of a target object is necessary or not on the basis of the relationship between the angle of the surface of the target object and reflectivity in FIG. 10 and on the basis of pixel values (brightness values) in a pattern projection image, a grayscale image, or both.

The step 21 (S21) is a process in which the arithmetic processing unit 4 determines whether correction is necessary or not on the basis of the relative orientation of the measurement apparatus 100 and the target object 5 (measurement scene). In the measurement scene of the present embodiment, since there is a pile of the target objects 5 in a non-array state inside a pallet, the relative orientation of the target object and the measurement apparatus is unknown. Therefore, unlike the first embodiment, at this point in time, the arithmetic processing unit 4 determines that the correction of the entire area of the image should not be carried out.

The step 22 (S22) is a process in which the arithmetic processing unit 4 acquires the data of a table showing a relationship between pixel values (brightness values) in an image and the ratio of improvement in precision as a result of the correction of an error arising from the fine shape of a surface of a target object. The table data can be acquired by conducting a measurement while changing the angle of inclination of the target object in relation to the measurement apparatus. Specifically, the table is created by acquiring the relationship (data) between the pixel values in the pattern projection image or the grayscale image and the ratio of improvement in precision as a result of the correction of the error arising from the fine shape at the part where the approximate shape of the target object 5 is known. “The ratio of improvement in precision as a result of the correction of the error arising from the fine shape” is a value calculated by dividing measurement precision in the shape of the target object after the correction by measurement precision in the shape of the target object before the correction. According to the relationship between the angle of the surface of the target object and reflectivity in FIG. 10, the reflectivity is low under conditions deviated from the conditions of regular reflection (the angle of incidence: zero), and the reflectivity is high under conditions near the conditions of regular reflection. There is substantial linearity in relation to the angle of incidence under conditions deviated from the conditions of regular reflection (the angle of incidence: zero). It is nonlinear under conditions near the conditions of regular reflection, and the formulae (2) and (3) do not hold. Given a constant luminous intensity, the reflectivity corresponds to the pixel values (brightness values) in the image. Therefore, precision improvement effect will not be great if the reflectivity (pixel value) is greater than a predetermined value beyond which there is no linearity between the angle and the reflectivity. Precision improvement effect will be great if the reflectivity (pixel value) is less than the predetermined value.

The step 23 (S23) is a process in which the arithmetic processing unit 4 decides, out of the table prepared in the step S22, a threshold of the pixel values (brightness values) for determining whether the correction is necessary or not. The brightness threshold Iₜₕ is, for example, a brightness value beyond which no effect can be expected for improving precision as a result of the correction of an error arising from the fine shape of the surface of a target object. That is, it is a brightness value under angular conditions in which the ratio of improvement in precision is one. It is enough if the steps 22 and 23 are carried out once for each kind of parts (target objects). They may be skipped in the second and subsequent executions in a case of repetitive measurement of the same kind of parts.

The step 24 (S24) is a process in which the arithmetic processing unit 4 acquires the data of the grayscale image captured in S15 and the data of the pattern projection image captured in S11. The step 25 (S25) is a process in which the arithmetic processing unit 4 determines, for each partial area in the pattern projection image, whether the correction is necessary or not. In this process, first, the grayscale image or the pattern projection image is segmented into plural partial areas (for example, 2×2 pixels). Next, an average pixel value (average brightness value) is calculated for each of the partial areas. The average pixel value is compared with the brightness threshold calculated in the step 23. Each partial area where the average pixel value is less than the brightness threshold is set as an area for which the correction is necessary (correction area). Each partial area where the average pixel value is greater than the brightness threshold is set as an area for which the correction is not necessary. Though a method that involves segmentation into partial areas for the purpose of smoothening noise is described in the present embodiment, it may be determined for each pixel whether the correction is necessary or not, without area segmentation.

The step 26 (S26) is a process in which the arithmetic processing unit 4 corrects the pattern projection image by using the grayscale image. The pattern projection image is corrected by using the grayscale image for the correction areas decided in the step 25. The correction is performed on the basis of the aforementioned formula (2) or (3).

The foregoing is a description of the procedure of correction processing according to the present embodiment. With the present embodiment, in the target object, for each partial area except for those under near-regular-reflection conditions, it is possible to correct the error due to the effects of reflectivity distribution arising from the fine shape of the surface of the target object as in the first embodiment, resulting in improved measurement precision. Moreover, since the correction based on the aforementioned formula (2) or (3) is not applied to, in the target object, each partial area under near-regular-reflection conditions, it is possible to prevent a decrease in precision due to the correction. Since image correction is applied to not a whole but a part of areas in the captured pattern projection image, specifically, only to areas where an improvement can be expected as a result of the correction, it is possible to calculate the shape of the target object in its entirety with higher precision.

### Third Embodiment

A third embodiment will now be explained. The difference from the foregoing second embodiment lies in the procedure of correction of an error arising from the fine shape of the surface of a target object. Therefore, the point of difference only is explained here. In the second embodiment, on the basis of the pixel values of the pattern projection image or the pixel values of the grayscale image, the determination for each partial area in the image as to whether the correction is necessary or not is performed. In the present embodiment, this determination is performed on the basis of the rough orientation of the target object calculated from the image before the correction.

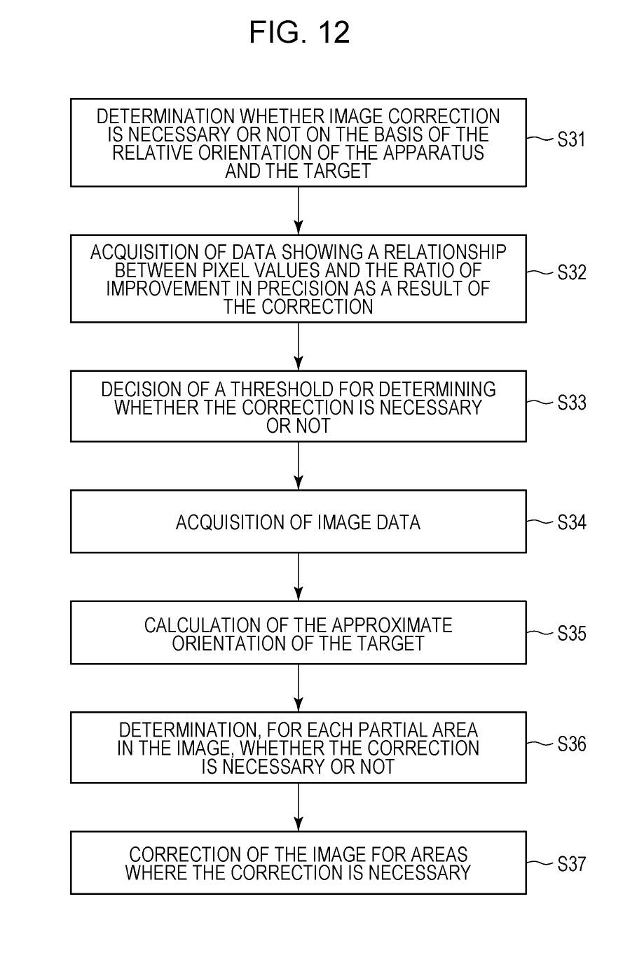

Procedure according to the present embodiment is illustrated in FIG. 12. Since the steps 31, 34, and 37 (S31, S34, and S37) are the same as the steps 21, 24, and 26 of the second embodiment respectively, they are not explained here.

The step 32 (S32) is a process in which the data of a table showing a relationship between the angle of inclination of a surface of a target object and the ratio of improvement in precision as a result of the correction of an error arising from the fine shape of the surface of the target object. The table is created by conducting a measurement while changing the angle of inclination of the target object in relation to the measurement apparatus and by acquiring the relationship between the angle of inclination of the surface of the target object and the ratio of improvement in precision as a result of the correction of the error arising from the fine shape at the part where the approximate shape of the target object 5 is known. The ratio of improvement in precision as a result of the correction of the error arising from the fine shape of the surface of the target object is, as in the second embodiment, a value calculated by dividing measurement precision after the correction by measurement precision before the correction. According to the relationship between the angle of the surface of the target object and reflectivity in FIG. 10, there is substantial linearity in relation to the angle of incidence under conditions deviated from the conditions of regular reflection, whereas it is nonlinear under conditions near the conditions of regular reflection, and the formulae (2) and (3) do not hold. Under the conditions of regular reflection, the angle of inclination of the surface of the target object is 0°. The greater the deviation from the conditions of regular reflection is, the greater the angle of inclination of the surface of the target object is. Therefore, precision improvement effect will be great if the angle of inclination of the surface of the target object is greater than a predetermined threshold beyond which there is no linearity between the angle and the reflectivity. Precision improvement effect will not be great if the angle of inclination of the surface of the target object is less than the predetermined threshold.

The step 33 (S33) is a process in which a threshold of orientation (the angle of inclination) for determining whether the correction is necessary or not is decided out of the table prepared in the step S32. The orientation threshold θₜₕ is, for example, an orientation value (the angle of inclination) beyond which no effect can be expected for improving precision as a result of the correction of an error arising from the fine shape of the surface of a target object. That is, it is an orientation value of the ratio of improvement in precision=1. It is enough if the steps 32 and 33 are carried out once for each kind of parts, as in the first embodiment. They may be skipped in the second and subsequent executions in a case of repetitive measurement of the same kind of parts.

The step 35 (S35) is a process in which the approximate orientation of the target object is calculated. In this process, a group of distance points and edges are calculated from the pattern projection image and the grayscale image acquired in the step 34, and model fitting is performed on a prepared-in-advance CAD model of the target object, thereby calculating the approximate orientation (approximate angle of inclination) of the target object. This approximate orientation of the target object is used as acquired-in-advance information on the shape of the target object. The step 36 (S36) is a process in which, with the use of the acquired-in-advance information on the shape of the target object, it is determined for each partial area in the pattern projection image whether the correction is necessary or not. In this process, the orientation (the angle of inclination) acquired in the step 35 for each pixel of the pattern projection image is compared with the orientation threshold decided in the step 33. In the pattern projection image, each partial area where the approximate orientation calculated in S35 is greater than the threshold is set as an area for which the correction is necessary (correction area), and each partial area where the approximate orientation calculated in S35 is less than the threshold is set as an area for which the correction is not necessary.

With the embodiment described above, as in the second embodiment, it is possible to correct a measurement error arising from the fine shape of the surface of a target object with high precision while preventing a decrease in precision at the near-regular-reflection region.

### Fourth Embodiment

A fourth embodiment will now be explained. The difference from the foregoing first embodiment lies in the grayscale image illumination unit 2. Therefore, the point of difference only is explained here. In the first embodiment, the grayscale image illumination unit 2 floodlights the target object 5 by means of direct light coming from the light sources 7. In the foregoing structure, the characteristics of the light sources 7 have a significant influence on the characteristics of the light for illuminating the target object 5 (wavelength, polarization, brightness, light distribution characteristics).

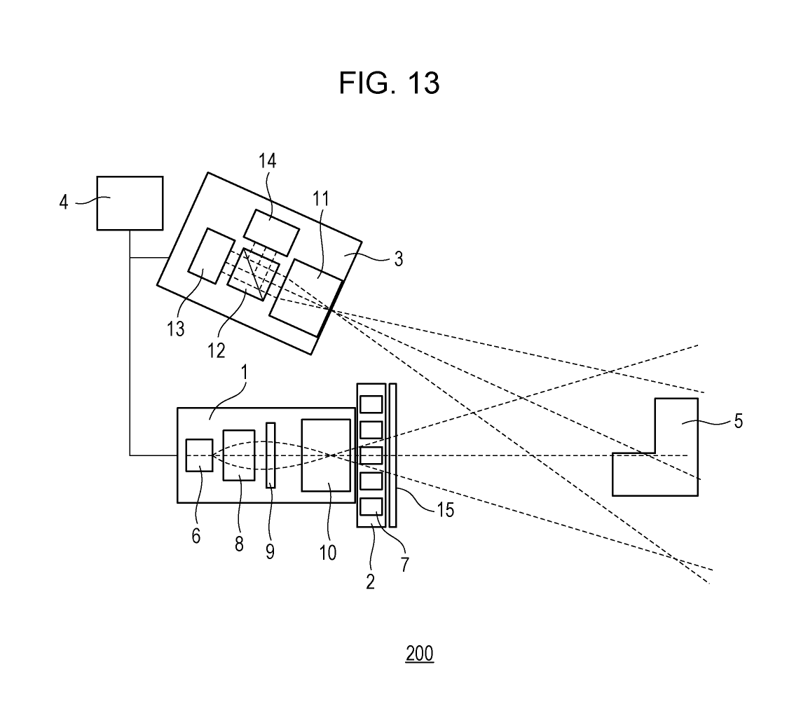

In view of the above, as illustrated in FIG. 13, a diffusion plate 15 (diffusion member) for optical diffusion is provided in the present embodiment. The diffusion plate 15 is, for example, a frosted glass plate. FIG. 13 is a schematic view of a measurement apparatus 200 according to the present embodiment. The same reference numerals are assigned to the same members as those of the measurement apparatus 100 illustrated in FIG. 1 to avoid redundant description. In the measurement apparatus 200, the light sources 7 may be arranged either symmetrically or asymmetrically with respect to the optical axis of the projection optical system 10. The light emitted from the light sources 7 in the grayscale image illumination unit 2 is diffused at the diffusion plate 15 into various directions. Therefore, the light coming from the diffusion plate 15 is similar to circumferential continuous emission source light around the optical axis of the projection optical system 10, which projects pattern light. In addition, it is possible to continuously equalize wavelength, polarization, brightness, and light distribution characteristics around the optical axis of the projection optical system 10. Therefore, it is possible to illuminate the target object 5 from two directions that are symmetric with each other with respect to the optical axis of the projection optical system 10. Let γ be the angle formed by the light for illuminating the target object 5 and the optical axis of the projection optical system 10. Given this definition, in a region where the angular characteristics of reflectivity are roughly linear, the approximate equation (1) holds. Therefore, local reflectivity distribution (light intensity distribution) for a pattern projection image and local reflectivity distribution for a grayscale image are roughly equal to each other. By performing image correction using the aforementioned formula (2) or (3), it is possible to correct an error due to the effects of reflectivity distribution of the target object.

With the embodiment described above, as in the first embodiment, it is possible to correct a measurement error due to the effects of reflectivity distribution on the surface of a target object with high precision even in a case where the relative position of the target object and the imaging unit changes.

Though exemplary embodiments are described above, the scope of the invention is not restricted to the exemplary embodiments. It may be modified in various ways within a range not departing from the gist of the invention. For example, though the two image sensors 13 and 14 are provided for imaging in the foregoing embodiments, a single sensor that is capable of acquiring a distance image and a grayscale image may be provided instead. In such a case, the wavelength division element 12 is unnecessary. The foregoing embodiments may be combined with one another. Though the light emitted by the light source 6 and the light sources 7 is explained as non-polarized light, the scope of the invention is not restricted thereto. It may be linearly polarized light of the same polarization direction. It may be polarized light as long as the state of polarization is the same. The plural light emitters may be mechanically coupled by means of a coupling member, a supporting member, or the like. A single ring-shaped light source may be adopted instead of the plural light sources 7. The disclosed measurement apparatus may be applied to a measurement apparatus that performs measurement by using a plurality of robot arms with imagers, or a measurement apparatus with an imaging unit provided on a fixed supporting member. The measurement apparatus may be mounted on a fixed structure, not on a robot arm. With the use of data on the shape of a target object measured by the disclosed measurement apparatus, the object may be processed, for example, machined, deformed, or assembled to manufacture an article, for example, an optical part or a device unit.

### ADVANTAGES

With some aspects of the invention, even in a case where the relative position of a target object and an imaging unit changes, it is possible to reduce a measurement error arising from the surface roughness of the target object, thereby measuring the shape of the target object with high precision.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-138158, filed Jul. 9, 2015, which is hereby incorporated by reference herein in its entirety.

1. A measurement apparatus for measuring a shape of a target object, comprising:
a projection optical system configured to project pattern light onto the target object;
an illumination unit configured to illuminate the target object;
an imaging unit configured to image the target object onto which the pattern light has been projected by the projection optical system, thereby capturing a first image of the target object by the pattern light reflected by the target object; and
a processing unit configured to obtain information on the shape of the target object,
wherein the illumination unit includes plural light emitters arranged around an optical axis of the projection optical system symmetrically with respect to the optical axis of the projection optical system,
wherein the imaging unit images the target object illuminated by the plural light emitters to capture a second image by light emitted from the plural light emitters and reflected by the target object,
wherein the processing unit corrects the first image by using the second image of the target object and obtains the information on the shape of the target object on the basis of the corrected image.

2. A measurement apparatus for measuring a shape of a target object, comprising:
a projection optical system configured to project pattern light onto the target object;
an illumination unit configured to illuminate the target object;
an imaging unit configured to image the target object onto which the pattern light has been projected by the projection optical system, thereby capturing a first image of the target object by the pattern light reflected by the target object; and
a processing unit configured to obtain information on the shape of the target object,
wherein the illumination unit includes plural light emitters arranged around an optical axis of the projection optical system, and
a diffusion member configured to diffuse the light emitted from the plural light emitters,
wherein the imaging unit images the target object illuminated by light from the diffusion member to capture a second image by light emitted from the diffusion member and reflected by the target object,
wherein the processing unit corrects the first image by using a second image of the target object and obtains the information on the shape of the target object on the basis of the corrected image.

3. The measurement apparatus according to claim 1,
wherein the plural light emitters are products of the same model number.

4. The measurement apparatus according to claim 2,
wherein the plural light emitters are products of the same model number.

5. The measurement apparatus according to claim 1,
wherein the plural light emitters have same characteristics of wavelength, polarization, brightness, and light distribution.

6. The measurement apparatus according to claim 2,
wherein the plural light emitters have same characteristics of wavelength, polarization, brightness, and light distribution.

7. The measurement apparatus according to claim 1,
wherein the processing unit corrects a part of plural partial areas of the first image.

8. The measurement apparatus according to claim 2,
wherein the processing unit corrects a part of plural partial areas of the first image.

9. The measurement apparatus according to claim 7,
wherein the processing unit determines, for each of the partial areas of the first image, whether correction is necessary or not by using a pixel value of either the first image or the second image, or both.

10. The measurement apparatus according to claim 8,
wherein the processing unit determines, for each of the partial areas of the first image, whether correction is necessary or not by using a pixel value of either the first image or the second image, or both.

11. The measurement apparatus according to claim 9,
wherein the processing unit determines, for each of the partial areas of the first image, whether the correction is necessary or not by comparing the pixel value in each of the partial areas of either the first image or the second image, or both, with a predetermined threshold.

12. The measurement apparatus according to claim 10,
wherein the processing unit determines, for each of the partial areas of the first image, whether the correction is necessary or not by comparing the pixel value in each of the partial areas of either the first image or the second image, or both, with a predetermined threshold.

13. The measurement apparatus according to claim 7,
wherein the processing unit determines, for each of the partial areas of the first image, whether correction is necessary or not by using information having been acquired in advance on the shape of the target object.

14. The measurement apparatus according to claim 8,
wherein the processing unit determines, for each of the partial areas of the first image, whether correction is necessary or not by using information having been acquired in advance on the shape of the target object.

15. The measurement apparatus according to claim 13,
wherein the processing unit determines, for each of the partial areas of the first image, whether the correction is necessary or not by comparing an angle of inclination at each region in the shape of the target object, the information on which has been acquired in advance, with a predetermined threshold.

16. The measurement apparatus according to claim 14,
wherein the processing unit determines, for each of the partial areas of the first image, whether the correction is necessary or not by comparing an angle of inclination at each region in the shape of the target object, the information on which has been acquired in advance, with a predetermined threshold.

17. The measurement apparatus according to claim 1,
wherein the imaging unit includes a first imaging unit configured to capture the first image of the target object by the pattern light reflected by the target object, and
a second imaging unit configured to capture the second image of the target object by light emitted from the plural light emitters and reflected by the target object, and
wherein the first imaging unit and the second imaging unit image the target object illuminated by the illumination unit, with the pattern light projected onto the target object.

18. The measurement apparatus according to claim 2,
wherein the imaging unit includes
a first imaging unit configured to capture the first image of the target object by the pattern light reflected by the target object, and
a second imaging unit configured to capture the second image of the target object by light emitted from the plural light emitters and reflected by the target object, and
wherein the first imaging unit and the second imaging unit image the target object illuminated by the illumination unit, with the pattern light projected onto the target object.

19. The measurement apparatus according to claim 1,
wherein the imaging unit performs imaging of the target object by the pattern light reflected by the target object and imaging of the target object by light emitted from the illumination unit and reflected by the target object in synchronization with each other.

20. The measurement apparatus according to claim 2,
wherein the imaging unit performs imaging of the target object by the pattern light reflected by the target object and imaging of the target object by the light emitted from the illumination unit and reflected by the target object in synchronization with each other.

21. The measurement apparatus according to claim 1,
wherein a state of polarization of the pattern light is the same as a state of polarization of light from the illumination unit.

22. The measurement apparatus according to claim 2,
wherein a state of polarization of the pattern light is the same as a state of polarization of light from the illumination unit.

23. The measurement apparatus according to claim 1,
wherein a wavelength of the pattern light is different from a wavelength of light from the illumination unit.

24. The measurement apparatus according to claim 2,
wherein a wavelength of the pattern light is different from a wavelength of light from the illumination unit.

25. The measurement apparatus according to claim 17, further comprising:
a wavelength division element,
wherein a wavelength of the pattern light is different from a wavelength of the light coming from the illumination unit,
wherein the light reflected by the target object undergoes wavelength division by the wavelength division element, and
wherein the wavelength division element guides light of the wavelength of the pattern light toward the first imaging unit and guides light of the wavelength of the light coming from the illumination unit toward the second imaging unit.

26. The measurement apparatus according to claim 18, further comprising:
a wavelength division element,
wherein a wavelength of the pattern light is different from a wavelength of the light coming from the illumination unit,
wherein the light reflected by the target object undergoes wavelength division by the wavelength division element, and
wherein the wavelength division element guides light of the wavelength of the pattern light toward the first imaging unit and guides light of the wavelength of the light coming from the illumination unit toward the second imaging unit.

27. A measurement apparatus for measuring a shape of a target object, comprising:
a projection optical system configured to project pattern light onto the target object;
an illumination unit configured to illuminate the target object;
an imaging unit configured to image the target object onto which the pattern light has been projected by the projection optical system, thereby capturing a first image of the target object by the pattern light reflected by the target object; and
a processing unit configured to obtain information on the shape of the target object,
wherein the illumination unit is configured to illuminate the target object from two directions, with an optical axis of the projection optical system therebetween,
wherein the imaging unit images the target object illuminated from the two directions by the illumination unit to capture a second image by light emitted from the illumination unit and reflected by the target object,
wherein the processing unit corrects the first image by using the second image of the target object and obtains the information on the shape of the target object on the basis of the corrected image.

28. The measurement apparatus according to claim 27,
wherein the illumination unit includes plural light emitters arranged around the optical axis of the projection optical system symmetrically with respect to the optical axis of the projection optical system.

29. The measurement apparatus according to claim 27,
wherein the illumination unit includes
plural light emitters arranged around the optical axis of the projection optical system, and
a diffusion member configured to diffuse the light emitted from the plural light emitters.

30. A system for gripping and moving a physical object, comprising:
the measurement apparatus according to claim 1 configured to measure a shape of an object;
a gripping unit configured to grip the object; and
a control unit configured to control the gripping unit by using a measurement result of the object by the measurement apparatus.

31. A system for gripping and moving a physical object, comprising:
the measurement apparatus according to claim 2 configured to measure a shape of an object;
a gripping unit configured to grip the object; and
a control unit configured to control the gripping unit by using a measurement result of the object by the measurement apparatus.

32. A system for gripping and moving a physical object, comprising:
the measurement apparatus according to claim 27 configured to measure a shape of an object;
a gripping unit configured to grip the object; and
a control unit configured to control the gripping unit by using a measurement result of the object by the measurement apparatus.

33. A method for manufacturing an article, comprising:
a step of measuring a shape of a target object by using the measurement apparatus according to claim 1; and
a step of processing the target object by using a measurement result of the target object by the measurement apparatus, thereby manufacturing the article.

34. A method for manufacturing an article, comprising:
a step of measuring a shape of a target object by using the measurement apparatus according to claim 2; and
a step of processing the target object by using a measurement result of the target object by the measurement apparatus, thereby manufacturing the article.

35. A method for manufacturing an article, comprising:
a step of measuring a shape of a target object by using the measurement apparatus according to claim 27; and
a step of processing the target object by using a measurement result of the target object by the measurement apparatus, thereby manufacturing the article.
